(19) United States
(12) Patent Application Publication
(10) Pub. No.: US 2019/0230311 A1
(43) Pub. Date: Jul. 25, 2019

(54) VIDEO INTERFACE DISPLAY METHOD AND APPARATUS

(71) Applicant: TENCENT TECHNOLOGY (SHENZHEN) COMPANY LIMITED, Shenzhen (CN)

(72) Inventor: Fei He, Shenzhen (CN)

(73) Assignee: TENCENT TECHNOLOGY (SHENZHEN) COMPANY LIMITED, Shenzhen (CN)

(21) Appl. No.: 16/375,432

(22) Filed: Apr. 4, 2019

Related U.S. Application Data
(63) Continuation of application No. PCT/CN2017/117638, filed on Dec. 21, 2017.

(30) Foreign Application Priority Data
Jan. 5, 2017 (CN) 201710007619.9

(51) Int. Cl. H04N 5/445; G06F 16/74; G06F 3/0483; G06F 3/0485; G06F 17/21

(52) U.S. Cl. CPC H04N 5/44591; G06F 16/74; G06F 17/211; G06F 3/0485; G06F 3/0483

(57) ABSTRACT

Aspects of the present disclosure provide a method and a terminal device for video display. The terminal device includes processing circuitry to receive web page data of a page for displaying on a display screen of the terminal device. The processing circuitry determines, from the web page data, a video playback portion of the page that includes a video interface for displaying a video and at least one interactive page element associated with the video interface. The processing circuitry determines a scrolling value of the page based on which the page is scrolled with regard to the display screen to display the video playback portion in a specific area of the display screen. The processing circuitry fills preset display content in an area other than the specific area on the display screen such that the preset display content is displayed in the area other than the specific area.

### RELATED APPLICATION

This application is a continuation of International Application No. PCT/CN2017/117638, filed on Dec. 21, 2017, which claims priority to Chinese Patent Application No. 201710007619.9, entitled “VIDEO INTERFACE DISPLAY METHOD AND APPARATUS” filed with the Chinese Patent Office on Jan. 5, 2017. The entire disclosures of the prior applications are hereby incorporated by reference in their entirety.

### FIELD OF THE TECHNOLOGY

This application relates to the field of electronic technologies, and in particular, to a video interface display method and apparatus.

### BACKGROUND OF THE DISCLOSURE

A video playback client (such as a video playback client) can play a video for a user, to meet a user requirement. To support page interaction (e.g., an interaction between a user and a web page), the video playback client can combine and render a video interface and an interactive page element (for example, an advertisement switching button and an advertisement skipping button), so that the video interface and the interactive page element are located on a same to-be-displayed page. This enables the user to, when watching a video, click an advertisement switching button to enter an advertisement page or click an advertisement skipping button to display non-advertisement content, thereby implementing page interaction.

### SUMMARY

Aspects of the present disclosure provide a method and a terminal device for video display.

In some examples, the terminal device includes processing circuitry that receives web page data of a page for displaying on a display screen of the terminal device. The processing circuitry determines, from the web page data, a video playback portion of the page that includes a video interface for displaying a video and at least one interactive page element associated with the video interface. Then the processing circuitry determines a scrolling value of the page based on which the page is scrolled with regard to the display screen of the terminal device to display the video playback portion in a specific area of the display screen. The processing circuitry further fills preset display content in an area other than the specific area on the display screen such that the preset display content is displayed in the area other than the specific area and the video playback portion is displayed in the specific area on the display screen.

According to an aspect of the disclosure, the processing circuitry determines, from the web page data, position information and size information of the video playback portion of the page. The position information includes a vertex of the video playback portion in a coordinate system, and the size information of the video playback portion includes a height of the video playback portion.

According to an aspect of the disclosure, the processing circuitry determines a first scrolling value for the page based on the position information of the video playback portion. The first scrolling value is used for the page to be scrolled such that the video playback portion is displayed in the specific area.

According to an aspect of the disclosure, the processing circuitry further determines a second scrolling value for a page window of the terminal device based on the first scrolling value. The page window is used for displaying the page, and the second scrolling value is used for the page window to be scrolled such that the video playback portion is displayed in the specific area.

In some embodiments, the first scrolling value for the page is expressed as follows:

newScrollyY=videoY−(webviewHeight−videoHeight)/2,

where newScrollyY represents the first scrolling value for the page, videoY represents a vertical coordinate of the vertex of the video playback portion, webviewHeight represents a height of the display screen of the terminal device, and videoHeight represents the height of the video playback portion.

In some embodiments, the first scrolling value for the page is expressed as follows:

newScrollyY=min(max(0,videoY−(webviewHeight−videoHeight)/2),webHeight),

where newScrollyY represents the first scrolling value for the page, videoY represents the vertical coordinate of the vertex of the video playback portion, webviewHeight represents the height of the display screen, videoHeight represents the height of the video playback portion, webHeight represents a height of the page, min( ) represents a minimum value being output in response to inputs between a paired parentheses, and max( ) represents a maximum value being output in response to inputs between a paired parentheses.

In some embodiments, the second scrolling value for the page window is expressed as follows:

int offsetY=(webviewHeight−videoHeight)/2−videoY+ScrollY,

where int offsetY represents the second scrolling value for the page window, webviewHeight represents the height of the display screen, videoHeight represents the height of the video playback portion, videoY represents the vertical coordinate of the vertex of the video playback portion, and ScrollY represents first scrolling value for the page.

Aspects of the disclosure also provide a non-transitory computer-readable medium storing instructions which when executed by a computer for video decoding cause the computer to perform the method for video display.

### BRIEF DESCRIPTION OF THE DRAWINGS

To describe the technical solutions of the embodiments of this application or the related technology more clearly, the following briefly introduces the accompanying drawings required for describing the embodiments or the related technology. The accompanying drawings in the following description show some embodiments of this application, and a person of ordinary skill in the art may still derive other drawings from these accompanying drawings.

FIG. 1a is a schematic diagram of a network structure to which a video interface display method is applicable according to an embodiment of this application.

FIG. 1b is a schematic flowchart of a video interface display method according to an embodiment of this application.

FIG. 2 is a schematic diagram of an interface of a to-be-displayed page according to an embodiment of this application.

FIG. 3 is a schematic diagram of an interface according to another embodiment of this application.

FIG. 4 is a schematic diagram of an interface according to another embodiment of this application.

FIG. 5 is a schematic flowchart of a video interface display method according to an embodiment of this application.

FIG. 6 is a schematic structural diagram of a video interface display apparatus according to an embodiment of this application.

FIG. 7 is a schematic structural diagram of a video interface display apparatus according to an embodiment of this application.

FIG. 8 is a schematic structural diagram of a device terminal according to an embodiment of this application.

### DESCRIPTION OF EMBODIMENTS

The following clearly and completely describes the technical solutions in the embodiments with reference to the accompanying drawings in the embodiments. The described embodiments are some exemplary embodiments of this application and not to be taken in an exhaustive sense. All other embodiments obtained by a person of ordinary skill in the art based on the embodiments of this application shall fall within the scope of this application.

An embodiment of this application provides a method for video display in a terminal device. In the method, a target area of a to-be-displayed page is displayed in a preset display area on a display screen of the terminal device. The target area includes a video interface and a page interactive element. In addition, an area other than the preset display area on the display screen of the terminal device is filled with preset display information. Accordingly, by this method, on one hand, a unified video playback interface can be provided to a user, thereby improving user experience; on the other hand, page interaction can be supported, thereby avoiding low efficiency caused by incapability of page interaction, and reducing processing pressure.

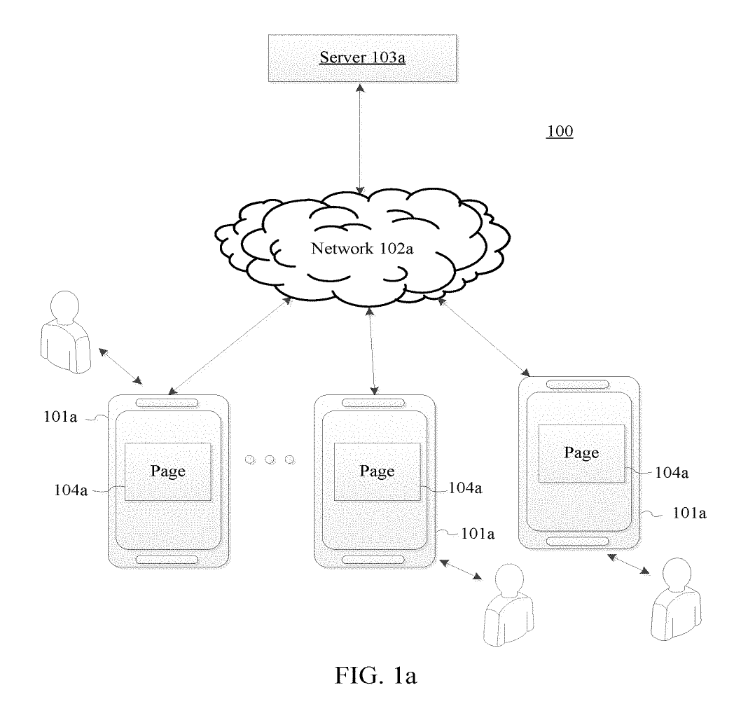

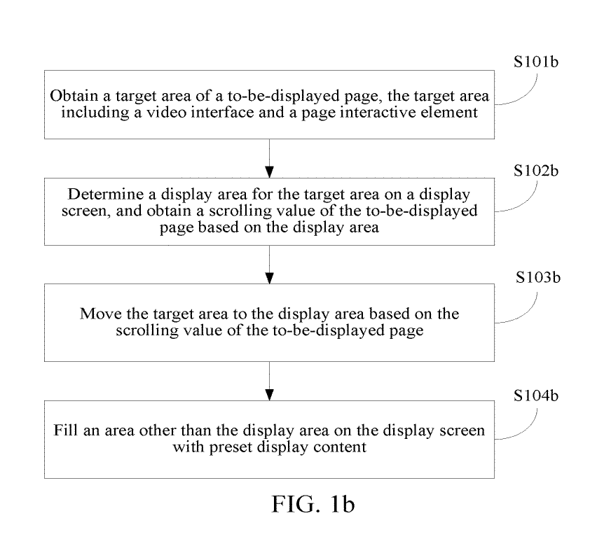

FIG. 1a is a diagram of a network structure to which a video interface display method is applicable according to an embodiment of this application. As shown in FIG. 1a, the network structure 100 includes at least the following components: a plurality of device terminals 101a, a network 102a, and a server 103a.

The device terminal 101a may be a device terminal such as a personal computer, a smartphone (for example, an Android phone or an iOS phone), a tablet computer, a palmtop computer, a mobile Internet device (MID) or a wearable intelligent device. Various clients such as a video playback client can run on the device terminal. The client running on the device terminal 101a may load and display a to-be-displayed page 104a by using a built-in browser.

The network 102a may include a wired network and a wireless network. As shown in FIG. 1a, on a side of an access network, the device terminal 101a may access the network 102a in a wireless or wired manner. On a side of a core network, the server 103a is usually connected to the network 102a in a wired manner. Certainly, the server 103a may alternatively be connected to the network 102a in a wireless manner.

The server 103a may be an application server such as a video playback server and provide a service to a user together with the client on the device terminal 101a, for example, play a video for the user. The server 103a may be an independent server or may be a cluster server including a plurality of servers.

An embodiment of this application provides a method for video display. The method includes obtaining a target area of a to-be-displayed page. A video interface and an interactive page element are within the target area. The method further includes determining a display area for the target area on a display screen of a terminal device and obtaining a scrolling value of the to-be-displayed page based on the display area. The method includes moving the target area to the display area based on the scrolling value of the to-be-displayed page and displaying a video through the video interface within the target area so that the video is displayed in the display area.

In an embodiment, if a display area is smaller than a display screen of a terminal device, an area on the display screen other than the display area is filled with preset display information. In such an embodiment, the preset display information is displayed in the area on the display screen other than the display area and the video is displayed in the display area, so that a user can focus on the video, thereby improving user experience.

As described above, the method for video display may run on a client running on a terminal such as a personal computer, a smartphone (for example, an Android phone or an iOS phone), a tablet computer, a palmtop computer, an MID or a wearable intelligent device. The client may include a video playback client, an instant messaging client, a social networking service (SNS) client, and the like. The client may display a video interface. The video interface is configured to play a video.

FIG. 1b is a schematic flowchart of a method for video display according to an embodiment of the present disclosure. As shown in FIG. 1b, the method may include at least the following steps:

S101b. Obtain a target area on a to-be-displayed page, the target area including a video interface and an interactive page element.

In an embodiment, a terminal may obtain a target area on a to-be-displayed page. The target area may include the video interface and the page element. The page element may include at least an interactive page element. The page element may also include at least a non-interactive page element. The video interface may display a video. The non-interactive page element may describe related information of the video that is currently displayed by the video interface. The interactive page element may provide interaction to a user so that the user can interact with the currently displayed video. In an example, when an advertisement is displayed by a video interface, a non-interactive page element may show remaining advertisement playback duration, and an interactive page element may provide a way (e.g., a click) for a user to enter an advertisement page for more information about the advertisement or perform advertisement switching so that the advertisement can be skipped. In another example, when a virtual reality (VR) video or a live broadcasting video is displayed by a video interface, an interactive page element may provide a way (e.g., a click) for a user to like the video or reward the video.

In an embodiment, the terminal may search for the to-be-displayed page by using a keyword entered by a user.

In an embodiment, the terminal may further obtain, when detecting a clicking operation of the user on an access path, address information or the like, a to-be-displayed page corresponding to the access path or address information.

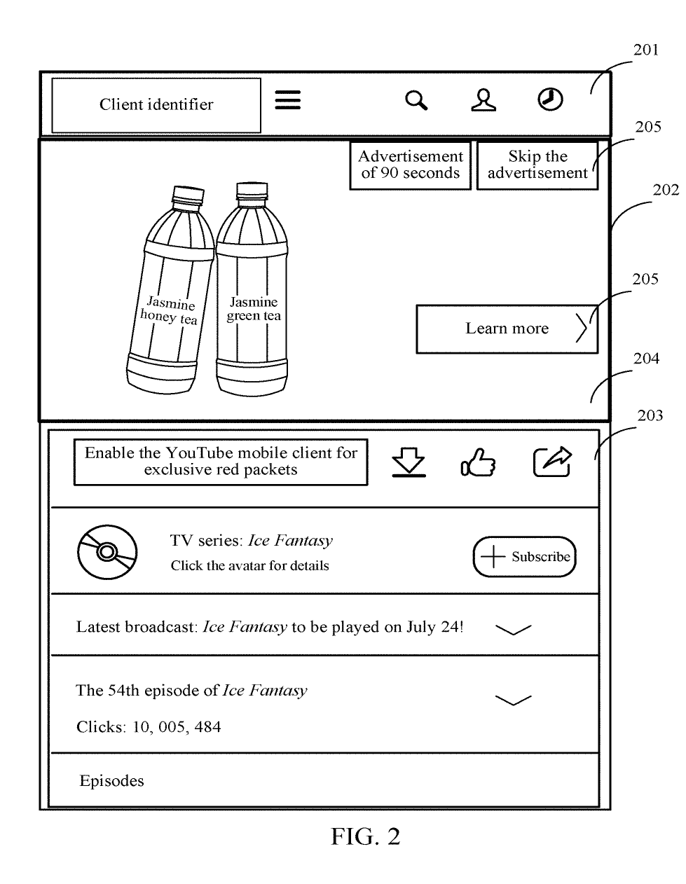

A schematic diagram of an interface of a to-be-displayed page in FIG. 2 is used as an example. The to-be-displayed page may include: a menu bar 201, a video interface 204, interactive page elements 205, and relevant information 203 of the video interface 204. The menu bar 201 may be located at the top of the to-be-displayed page. The menu bar 201 may include a client identifier of a video playback client, a login button instructing to log in to a video playback server, a search engine, and the like. The video interface 204 and the interactive page elements 205 may be located in a same area on the to-be-displayed page. For example, the video interface 204 and the interactive page elements 205 are located below the menu bar 201. In addition, a non-interactive page element is to show remaining playback duration of the displayed video. The relevant information 203 of the video interface 204 may be located below the video interface 204. The relevant information 203 may include a video name and an episode number of a video currently displayed through the video interface 204, a total number of playback request of the video, and the like. After obtaining the to-be-displayed page, the terminal may obtain an area that is on the to-be-displayed page and that includes the video interface 204 and the interactive page elements 205, and may use the area as a target area 202.

S102b. Determine a display area on a display screen for the target area, and obtain a scrolling value of the to-be-displayed page based on the display area.

In an embodiment, a terminal device may determine a display area on a display screen for a target area, and obtain a scrolling value of a to-be-displayed page based on the display area. The scrolling value is used for indicating a position of each area on the to-be-displayed page. The scrolling value of the to-be-displayed page is obtained based on the display area and updated accordingly.

In an embodiment, in a layout of a to-be-displayed page, a menu bar is located at the top of the to-be-displayed page, and a target area is located below the menu bar. Based on an initial scrolling value of the to-be-displayed page, the to-be-displayed page is displayed by a terminal device on a display screen as shown in FIG. 2. A height of the to-be-displayed page is greater than a height of the display screen, and consequently, the display screen cannot completely display the entire to-be-displayed page. To improve user experience, the terminal device may display the target area in a display area on the display screen. The display area may be an area that is preset by the terminal device. For example, the display area may be a middle area on the display screen. Further, the terminal device may obtain a scrolling value of the to-be-displayed page when the target area is located in the display area.

In an embodiment, the terminal device may update the scrolling value of the to-be-displayed page based on the display area to obtain an updated scrolling value of the to-be-displayed page.

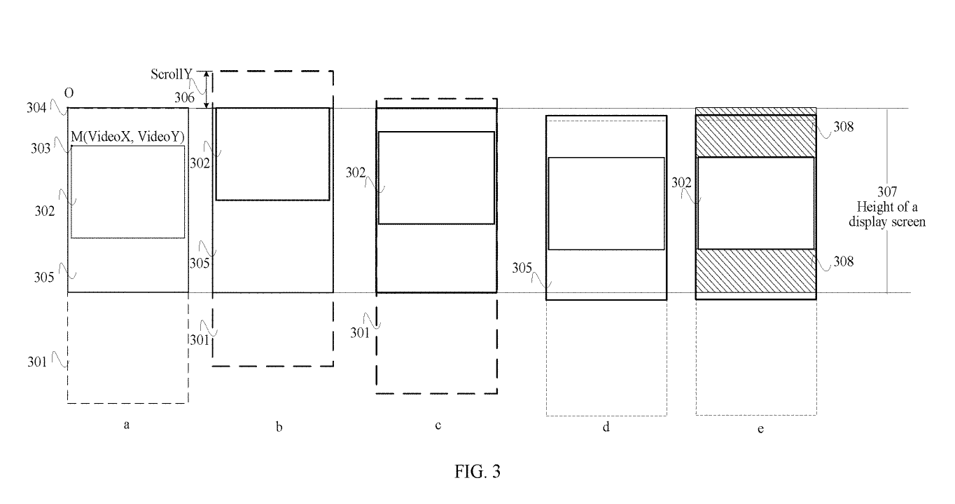

A schematic diagram of an interface shown in FIG. 3 is used as an example. A first area 301 may represent the entire to-be-displayed page, for example, a web page; a second area 302 may represent the target area and thus, is an area including a video interface and an interactive page element; a third area 305 may be used as a viewport for displaying the to-be-displayed page. The viewport may be a page window, for example, a page window provided by a built-in browser Webview of a video playback client and used for displaying a to-be-displayed page loaded by the browser. The viewport is usually of a same size as that of the display screen. Page content on the viewport may be displayed on the display screen. The terminal device may update a scrolling value of the to-be-displayed page based on the display area to obtain an updated scrolling value of the to-be-displayed page. For example, the terminal may move the to-be-displayed page, so that the target area is located in the display area.

In an embodiment, an updated scrolling value of a to-be-displayed page may be expressed as follows:

newScrollyY=videoY−(webviewHeight−videoHeight)/2, and

newScrollyX=videoX−(webviewLength−videoLength)/2,

where newScrollyY represents a Y value of the updated scrolling value of the to-be-displayed page, videoY represents an original Y value of a target area, webviewHeight represents a height of a display screen, videoHeight represents a height of the target area; newScrollyX represents an X value of the updated scrolling value of the to-be-displayed page, videoX represents an original X value of the target area, webviewLength represents a length of the display screen, and videoLength represents a length of the target area.

In an embodiment, an updated scrolling value of a to-be-displayed page may be expressed as follows:

newScrollyY′=min(max(0,newScrollyY),webHeight), and

newScrollyX′=min(max(0,newScrollyX),webLength),

where newScrolly Y′ represents a Y value of a newest scrolling value of the to-be-displayed page, newScrollyY represents a Y value of a previously updated scrolling value of the to-be-displayed page, webHeight represents a height of the to-be-displayed page; newScrolly X′ represents an X value of the newest scrolling value of the to-be-displayed page, newScrollyX represents an X value of a previously updated scrolling value of the to-be-displayed page, and webLength represents a length of the to-be-displayed page.

In an embodiment of the present disclosure, the scrolling value of the to-be-displayed page is updated based on the display area, so that the target area can be ensured to be located in the display area based on the updated scrolling value of the to-be-displayed page.

In an embodiment, after updating the scrolling value of the to-be-displayed page based on the display area, when determining, based on the updated scroll value, that the target area is located in an area on the display screen other than the displayed area, the terminal device may move the target area, so that the moved target area is located in the display area on the display screen.

The schematic diagram of the interface shown in FIG. 3 is used as an example. The terminal device moves a to-be-displayed page in a first state (as shown by a) in FIG. 3 based on the updated scrolling value of the to-be-displayed page. The moved to-be-displayed page may be shown as a to-be-displayed page in a second state (as shown by b) in FIG. 3. The terminal device may determine that the second area 302 on the moved to-be-displayed page is located at an upper part on the display screen and is not at the middle part on the display screen. In other words, the second area 302 is located in an area of the display screen other than the display area. Therefore, the terminal device may move the second area 302, so that the moved second area 302 is located in the display area on the display screen.

In an embodiment, an updated scrolling value of the target area may be expressed as follows:

int offsetY=(webviewHeight−videoHeight)/2−videoY+ScrollY, and

int offsetX=(webviewLength−videoLength)/2−videoX+ScrollX,

where int offsetY represents a Y value of the updated scrolling value of the target area, webviewHeight represents a height of the display screen, and videoHeight represents a height of the target area, videoY represents an original Y value of the target area, ScrollY represents a Y value of the scrolling value of the to-be-displayed page; int offsetX represents an X value of the updated scrolling value of the target area, webviewLength represents a length of the display screen, videoLength represents a length of the target area, videoX represents an original X value of the target area, and ScrollX represents an X value of the scrolling value of the to-be-displayed page.

In an embodiment, the terminal device may update the scrolling value of the target area based on the display area to obtain the updated scrolling value of the target area.

In an embodiment, the terminal device may update the scrolling value of the target area based on the display area, so that the target area may be moved to the display area based on the updated scrolling value of the target area.

In an embodiment, after updating the scrolling value of the target area based on display area, when determining, based on the updated scrolling value of the target area, that the target area is located in the area of the display screen other than the display area, the terminal may update the scrolling value of the to-be-displayed page, to obtain the updated scrolling value of the to-be-displayed page.

In an embodiment of the present disclosure, a manner in which the target area is moved to the display area includes but is not limited to: updating the scrolling value of the to-be-displayed page; or updating a position of the target area relative to the to-be-displayed page; or updating a position of the target area relative to the to-be-displayed page after updating the scrolling value of the to-be-displayed page; or updating the scrolling value of the to-be-displayed page after updating a position of the target area relative to the to-be-displayed page.

S103b. Move the target area to the display area based on the scrolling value of the to-be-displayed page.

The terminal may move the target area to the display area based on the scrolling value of the to-be-displayed page. The schematic diagram of the interface shown in FIG. 3 is used as an example. The second area 302 moved to the third area 305 may be shown as a to-be-displayed page in a third state (as shown by c) in FIG. 3.

S104b. Fill an area on the display screen other than the display area with preset display information. In an embodiment, a terminal device may fill an area on the display screen other than the display area with the preset display information. The preset display information may be a black block placeholder. In an example, the area on the display screen other than the display area may be filled with black color. In another example, the preset display information may be a preset image, text, or the like. The terminal device may fill the area on the display screen other than the display area with display information corresponding to the to-be-displayed page. For example, the terminal device may fill the area on the display screen other than the display area with different display information for different to-be-displayed pages.

In a related example (e.g., Chrome browser that uses composite layer rendering mode) for video playback, page elements (interactive page elements and non-interactive page elements) and video of the to-be-displayed page are composited and rendered by a video playback client based on configurations of a video control panel of the video playback client. Video control panels of different video playback clients have different configurations. The different video playback clients will render the to-be-displayed page differently, and the different video playback clients lack a unified video playback interface thereby decreasing user experience.

In another related example (e.g., UC browser that uses a native rendering mode), video in the to-be-displayed page is rendered separately from other page elements, and thus user interactions are not supported.

Some aspects of the present disclosure provide method and apparatus to provide a unified video playback interface that supports user interactions. In some embodiments, the video and associated page elements (non-interactive page elements and interactive page elements) in the to-be-displayed page are suitably positioned in a specific (e.g., center) display region on a display screen. In some examples, the non-video portions in the to-be-displayed page are hided. Thus, different video playback clients display the video with the page elements (non-interactive elements and interactive elements) associated with the video in a relatively unified manner, and support user interactions.

A schematic diagram of an interface shown in FIG. 4 is used as an example. There are two areas on a display screen 400: a display area 403 and an area 402 other than the display area 403. A target area 401 is an area of a web page. A video interface 404 and interactive page elements 405 are within the target area 401.

In an embodiment, an advertisement is displayed through the video interface 404 within the target area 401. The interactive page elements 405 are also displayed within the target area 401 such that a user can interact with the advertisement through the interactive page elements 405. In the example illustrated in FIG. 4, an advertisement is displayed through the video interface 404, and three page elements are displayed within the target area 401. It is noted that the target area 401 can also include other suitable page elements, such as non-interactive page elements. In the FIG. 4 example, a non-interactive page element that indicates remaining playback duration of the currently displayed advertisement, e.g. 90 seconds is in the target area 401. Further, in the FIG. 4 example, two interactive page elements are in the target area 401. One of the two interactive page elements is located in upper right corner of the target area 401 and is used to skip the currently displayed advertisement, so that a user can click this interactive page element to skip the currently displayed advertisement. The other interactive page element is located in lower right of the target area 401 and is used to switch to a web page associating with the currently displayed advertisement when a user wants to learn more about the currently displayed advertisement.

In an embodiment, the terminal device moves the target area 401 to the display area 403, and fills the area 402 with preset display information. The interactive page elements 405 are displayed on the video interface 404 by drawing the interactive page elements 405 on a same layer on which the video interface 404 is located, so that the video interface 404 and the interactive page elements 405 are located within the display area 403, thereby implementing page interaction. In addition, the video interface 404 is centrally displayed and page content within the area 402 is hidden by the preset display information, thereby improving user experience.

In an embodiment, the target area 401 on the to-be-displayed page is obtained. The display area 403 on the display screen 400 for the target area 401 is determined, and thus the scrolling value of the to-be-displayed page is obtained based on the display area 403. The target area 401 is moved to the display area 403 based on the scrolling value of the to-be-displayed page. The area 402 is filled with the preset display information. The video interface 404 and the interactive page elements 405 are displayed in the display area 403, thereby improving user experience.

An embodiment provides a method for video display in a terminal device. In such a method, a target area is displayed in a preset display area on a display screen of the terminal device. The target area includes a video interface and a page interactive element. In addition, an area on the display screen other than the preset display area is filled with preset display information. By this method, on one hand, a unified video playback interface can be provided to a user, thereby improving user experience; on the other hand, page interaction can be supported, thereby avoiding low efficiency caused by incapability of page interaction, and reducing processing pressure.

The method for video display may be run on a client that runs on the device terminal 101a. The client may include a video playback client, an instant messaging client, a simple notification service (SNS) client, and the like. The client may process a video interface. The video interface is configured to play a video.

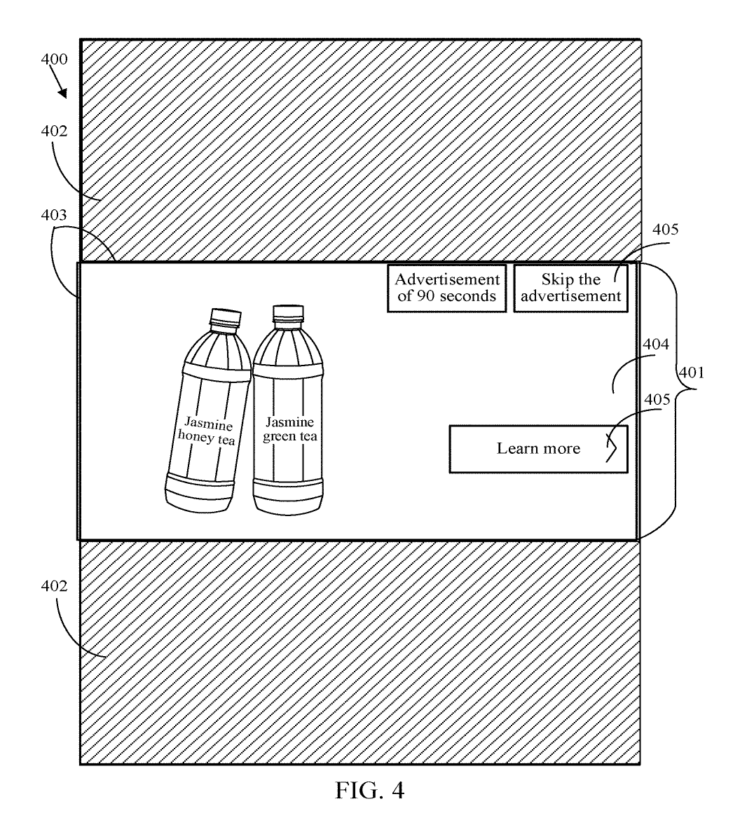

FIG. 5 is a schematic flowchart of a video interface display method according to an embodiment of this application. As shown in FIG. 5, the video interface display method may include at least the following steps:

S501. Receive web page data.

In some embodiments, in response to a clicking operation of a user on a link, the video playback client running on the device terminal 101a receives web page data corresponding to the link from the server 103a, loads (e.g., compiles, downloads, builds, and renders, etc.) a to-be-displayed page corresponding to the web page data by using a built-in browser such as Webview, and displays the to-be-displayed page by using a page window provided by the browser. The to-be-displayed page may be a web page.

Herein, the web page data is used for displaying a to-be-displayed page by using a page window of a video playback terminal. The to-be-displayed page includes a target area and an area other than the target area, and the target area includes a video interface and a page interactive element.

In some embodiments, the target area may also be referred to as a video playback area. The target area may include the video interface and the page elements. The video interface may be configured to play a video. The page elements may include non-interactive page elements and interactive page elements. The non-interactive page elements may be configured to describe related information of the video that is displayed by the video interface and the interactive page elements may provide interaction to a user so that the user can interact with the currently displayed video. In an example, when an advertisement is displayed by a video interface, a non-interactive page element may show remaining advertisement playback duration, and an interactive page element may provide a way (e.g., a click) for a user to enter an advertisement page if the user is interested in learning more about the advertisement, or skip the advertisement if the user is not interested in the advertisement. In another example, when a virtual reality video or a live video is displayed by a video interface, an interactive page element may provide a way (e.g., a click) for a user to like the video or reward the video. As described above, the area other than the display area may also be referred to as a non-playback area, which may include a menu bar, relevant or specific information of the video program, and the like.

The schematic diagram of the interface of the to-be-displayed page shown in FIG. 2 is used as an example. The to-be-displayed page may include a target area 202 (an area shown by a bold solid line) and a non-target area (e.g., non-playback area). The target area 202 includes a video interface 204 and an interactive page element 205. The non-playback area includes a menu bar 201 and relevant information 203 of the video interface 204. The menu bar 201 may be located at the top of the to-be-displayed page. The menu bar 201 may include a video identifier of a video playback client that could be an icon or image or title illustrating the distinct feature of the video, a login button instructing a user to log in to a video playback server, a search engine, and the like. The video interface 204 and the interactive page element 205 may be located within a same display area on the to-be-displayed page. For example, the video interface 204 and the interactive page element 205 are located below the menu bar 201. The relevant information 203 of the video interface 204 may be located below the video interface 204. The relevant information 203 may include a video name and an episode number of a video currently played on the video interface 204, a total number of playback request of the video, and the like. After obtaining the to-be-displayed page, the terminal device may obtain an area that is on the to-be-displayed page and that includes the video interface 204 and the interactive page element 205 and use the area as the target area 202.

S502. Obtain position information and size information of the target area on the to-be-displayed page.

In some instances, the client may obtain the position information and the size information of the target area on the to-be-displayed page in response to a playback request of the user. The playback request may be an operation request of the user clicking the target area, for example, a clicking operation on the target area. The position information is coordinate information of the target area relative to the to-be-displayed page. In some embodiments, the position information is coordinate information of an upper left corner of the target area relative to an upper left corner of the to-be-displayed page. Therefore, the position information of the target area is fixed on a to-be-displayed page. In other words, a relative position of the target area on the to-be-displayed page is unchanged.

FIG. 3 shows an example of the to-be-displayed page. As shown in FIG. a of FIG. 3, an area shown by a broken line box is a to-be-displayed page 301, and an area shown by a bold solid line box is a target area 302. The target area 302 is located within the to-be-displayed page 301. Position information of the target area 302 may be represented by coordinates (VideoX, VideoY) of a point M 303 at the upper left corner of the target area 302 relative to a point O 304 at the upper left corner of the to-be-displayed page 301. The point O 304 is a coordinate origin. It can be learned that the position information of the target area 302 on the to-be-displayed page 301, i.e., the coordinates (VideoX, VideoY) of the point M, is fixed.

S503. Determine a display area on a display screen for the target area, and obtain a scrolling value of at least one of the to-be-displayed page and a page window based on the display area.

In some instances, the display area may be a preset area. A size of the display area may be determined based on a size of the target area, and the display area may be centrally located on the display screen. Therefore, the video playback client may determine position information and size information of the display area based on the position information and the size information of the target area.

In some embodiments, the to-be-displayed page is loaded by the built-in browser such as Webview of the video playback client and displayed by the page window provided by the browser on the display screen. In some embodiments, a size of the page window is the same as that of the display screen. In other embodiments, the size of the page window may alternatively be different from that of the display screen, and content in the page window is likely to be displayed on the display screen. An initial displayed state of the to-be-displayed page is that the upper left corner of the to-be-displayed page overlaps an upper left corner of the page window. In an embodiment, if before requesting playback, the user scrolls the to-be-displayed page to browse the to-be-displayed page, the to-be-displayed page has a scrolling value relative to the page window. The scrolling value may be an initial scrolling value. It is noted that, whether or not the to-be-displayed page has an initial scrolling value does not impact on a first scrolling value based on which the to-be-displayed page is to be moved.

FIG. 3 is still used as an example. After the to-be-displayed page 301 is loaded, the initial state is that the upper left corner of the to-be-displayed page 301 overlaps the upper left corner of the page window 305 such as Webview, as shown in FIG. a of FIG. 3. The page window 305 is an area shown by a solid line box. If the user scrolls the to-be-displayed page 301 to browse the to-be-displayed page 301 before requesting playback, the to-be-displayed page 301 has a scrolling value relative to the page window 305. The scrolling value may also be referred to as an initial scrolling value, as shown in FIG. b of FIG. 3. Based on the initial scrolling value of the to-be-displayed page, the to-be-displayed page displayed on the display screen of the client may be shown in FIG. b of FIG. 3. The target area 302 is located at an upper part of the display screen. To improve user experience, the client may move the to-be-displayed page 301, so that the target area 302 is displayed in the display area on the display screen. In some instances, the display area is centrally located on the display screen and has a same size as that of the target area 302.

In some embodiments, the first scrolling value of the to-be-displayed page is determined based on the position information and the size information of the target area, the first scrolling value allowing the target area to be displayed in the display area. In some embodiments, assuming that the display area is centrally located on the screen and has a same size as that of the target area. In this case, to display the target area in the display area, the first scrolling value based on which the to-be-displayed page is to be moved may be obtained by subtracting a sum of a vertical coordinate in the position information of the target area and a height of the target area from a half of a height of the screen. This may be expressed as follows through collation:

newScrollyY=videoY−(webviewHeight−videoHeight)/2,

where newScrollyY represents the determined first scrolling value by which the to-be-displayed page is to be moved, videoY represents a vertical coordinate of an upper left vertex of the target area, webviewHeight represents the height of the display screen, and videoHeight represents the height of the target area.

In some embodiments, because newScrollyY may be a negative value, the first scrolling value by which the to-be-displayed page is to be moved may be expressed as follows:

newScrollyY=min(max(0,video−(webviewHeight−videoHeight)/2),webHeight),

where newScrollyY represents the first scrolling value by which the to-be-displayed page is to be moved, webHeight represents a height of the to-be-displayed page, webviewHeight represents a height of the display screen, and videoHeight represents a height of the target area.

In some embodiments, if after the to-be-displayed page is moved based on the first scrolling value, the target area is located in the display area, and step S505 is directly performed. In other embodiments, if after the to-be-displayed page is moved based on the first scrolling value, the target area is not located in the display area, a second scrolling value by which the page window is to be moved is to be further determined based on the first scrolling value of the to-be-displayed page, the second scrolling value allowing the target area to be displayed in the display area.

In some embodiments, to allow the target area to be located in the display area, the second scrolling value by which the page window is to be moved may be expressed as follows:

int offsetY=(webviewHeight−videoHeight)/2−videoY+ScrollY,

where int offsetY represents the second scrolling value of the page window, webviewHeight represents the height of the display screen, videoHeight represents the height of the target area, videoY represents a vertical coordinate in the position information of the target area, and ScrollY represents the first scrolling value of the to-be-displayed page.

S504 Move the at least one of the to-be-displayed page and the page window based on the scrolling value in order to display the target area in the display area on the display screen.

In some embodiments, the video playback client moves the to-be-displayed page based on the first scrolling value by which the to-be-displayed page is to be moved, so that the target area on the moved to-be-displayed page is displayed in the display area on the display screen.

In some embodiments, the video playback client moves the to-be-displayed page based on the first scrolling value by which the to-be-displayed page is to be moved, and then moves the page window based on the second scrolling value by which the page window is to be moved, so that the target area on the moved to-be-displayed page is displayed in the display area on the display screen.

FIG. 3 is still used as an example. The video playback client moves the to-be-displayed page 301 in the state shown in FIG. b of FIG. 3 based on the determined first scrolling value, and the moved to-be-displayed page may be shown as a to-be-displayed page in a state in FIG. c of FIG. 3. The video playback client may determine that the target area 302 on the moved to-be-displayed page 301 is still not located in a middle area on the display screen, e.g., the target area 302 is not located in the display area on the display screen. Therefore, the video playback client may move the page window 305, so that the target area 302 after the movement is located in the display area on the display screen, as shown in FIG. d of FIG. 3.

S505. Fill an area on the display screen other than the display area with preset display information in order to hide page content in the area on the display screen other than the display area.

The video playback client may fill the area on the display screen other than the display area with the preset display information. The preset display information may be a black block placeholder. For example, the area on the display screen other than the display area may be filled with black color. In some instances, the preset display information may be a preset image, text, or the like. The video playback client may fill the area on the display screen other than the display area with display information corresponding to the to-be-displayed page. For example, the video playback client may fill the area on the display screen other than the display area with different display information for different to-be-displayed pages.

Using FIG. e in FIG. 3 as an example, the target area 302 is located in the display area, so that an area 308 other than the target area 302 is filled with preset display information such as diagonal stripes.

Further, the schematic diagram of the interface shown in FIG. 4 is used as an example. The client displays a target area 401 in a preset display area 403, and fills an area 402 on the display screen 400 other than the target area 401 with the preset display information. The to-be-displayed page filled with the preset display information may be shown in FIG. 4. An interactive page element 405 is displayed on a video interface 404 by drawing the interactive page element 405 on a same layer on which the video interface 404 is located, so that the video interface 404 and the interactive page element 405 are located within the display area 403, thereby implementing page interaction. In addition, the target area 401 is centrally displayed and page content within the area 402 other than the display area 403 on the display screen 400 is hidden by present display information, thereby improving user experience.

In an embodiment of this application, the target area is displayed in the preset display area, the target area including the video interface and the interactive page element, and the area on the display screen other than the preset display area is filled with the preset display information. By this method, on one hand, a unified video playback interface can be provided to a user, thereby improving user experience; on the other hand, page interaction can be supported, thereby avoiding low efficiency caused by incapability of page interaction, and reducing processing pressure.

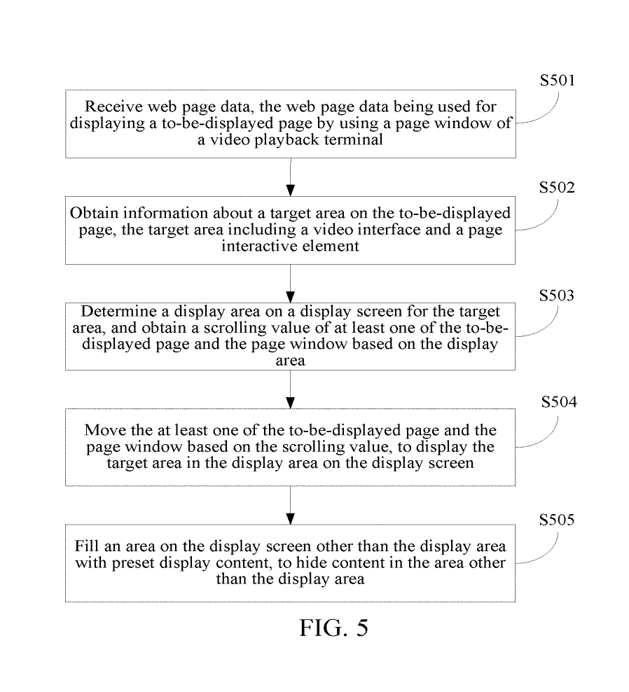

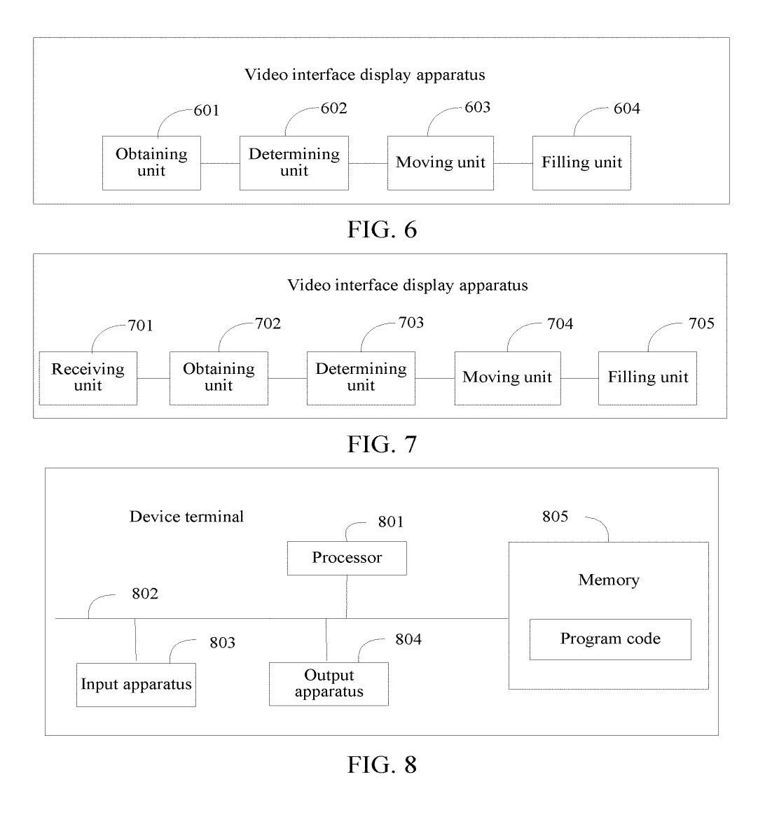

FIG. 6 is a schematic structural diagram of a video interface display apparatus according to an embodiment of this application. As shown in FIG. 6, the video interface display apparatus in this embodiment may include at least the following components: one or more memories; and one or more processors, the one or more memories storing one or more instruction modules configured to be executed by the one or more processors, and the one or more instruction modules including: an obtaining unit 601, a determining unit 602, a moving unit 603, and a filling unit 604.

The obtaining unit 601 is configured to obtain a target area on a to-be-displayed page, the target area including a video interface and an interactive page element.

The determining unit 602 is configured to: determine a display area on a display screen for the target area, and obtain a scrolling value of the to-be-displayed page based on the display area.

The moving unit 603 is configured to move the target area to the display area based on the scrolling value of the to-be-displayed page.

The filling unit 604 is configured to fill an area on the display screen other than the display area with preset display information.

In some embodiments, the determining unit 602 obtains the scrolling value of the to-be-displayed page based on the display area, and is configured to:

update the scrolling value of the to-be-displayed page based on the display area, to obtain the updated scrolling value of the to-be-displayed page.

In some embodiments, the determining unit 602 is further configured to: after updating the scrolling value of the to-be-displayed page based on the display area, when determining, based on the updated scrolling value, that the target area is located in the area on the display screen other than the display area, move the target area, so that the moved target area is located in the display area on the display screen.

In some embodiments, the updated scrolling value of the to-be-displayed page is expressed as follows:

newScrollyY=videoY−(webviewHeight−videoHeight)/2; and

newScrollyX=videoX−(webviewLength−videoLength)/2,

where newScrollyY represents a Y value of the updated scrolling value of the to-be-displayed page, videoY represents an original Y value of the target area, webviewHeight represents a height of the display screen, videoHeight represents a height of the target area; newScrollyX represents an X value of the updated scrolling value of the to-be-displayed page, videoX represents an original X value of the target area, webviewLength represents a length of the display screen, and videoLength represents a length of the target area.

In some embodiments, the updated scrolling value of the to-be-displayed page is expressed as follows:

newScrollyY′=min(max(0,newScrollyY),webHeight); and

newScrollyX′=min(max(0,newScrollyX),webLength),

where newScrolly Y′ represents a Y value of a newest scrolling value of the to-be-displayed page, newScrollyY represents a Y value of a previously updated scrolling value of the to-be-displayed page, webHeight represents a height of the to-be-displayed page; newScrolly X′ represents an X value of the newest scrolling value of the to-be-displayed page, newScrollyX represents an X value of the previously updated scrolling value of the to-be-displayed page, and webLength represents a length of the to-be-displayed page.

In some embodiments, the determining unit 602 obtains the scrolling value of the to-be-displayed page based on the display area, and is configured to:

update a scrolling value of the target area based on the display area, to obtain the updated scrolling value of the target area.

In some embodiments, the determining unit 602 is further configured to: after updating the scrolling value of the target area based on the display area, when determining, based on the updated scrolling value of the target area, that the target area is located in the area on the display screen other than the display area, update the scrolling value of the to-be-displayed page, to obtain the updated scrolling value of the to-be-displayed page.

In some embodiments, the updated scrolling value of the target area is expressed as follows:

int offsetY=(webviewHeight−videoHeight)/2−videoY+ScrollY; and

int offsetX=(webviewLength−videoLength)/2−videoX+ScrollX,

where int offsetY represents a Y value of the updated scrolling value of the target area, webviewHeight represents a height of the display screen, and videoHeight represents a height of the target area, videoY represents an original Y value of the target area, ScrollY represents a Y value of the scrolling value of the to-be-displayed page; int offsetX represents an X value of the updated scrolling value of the target area, webviewLength represents a length of the display screen, videoLength represents a length of the target area, videoX represents an original X value of the target area, and ScrollX represents an X value of the scrolling value of the to-be-displayed page.

In this embodiment of the present disclosure, the obtaining unit 601 obtains the target area on the to-be-displayed page, the target area including the video interface and the interactive page element; the determining unit 602 determines the display area on the display screen for the target area, and obtains the scrolling value of the to-be-displayed page based on the display area; the moving unit 603 moves the target area to the display area based on the scrolling value of the to-be-displayed page; the filling unit 604 fills the area on the display screen other than the display area with the preset display content. This can improve user experience.

FIG. 7 is a schematic structural diagram of a video interface display apparatus according to an embodiment of this application. As shown in FIG. 7, the video interface display apparatus in this embodiment may include at least the following components: one or more memories; and one or more processors, the one or more memories storing one or more instruction modules configured to be executed by the one or more processors, and the one or more instruction modules including: a receiving unit 701, an obtaining unit 702, a determining unit 703, a moving unit 704, and a filling unit 705.

The receiving unit 701 is configured to receive web page data, the web page data being used for displaying a to-be-displayed page by using a page window of the video playback terminal.

The obtaining unit 702 is configured to obtain information about a target area on the to-be-displayed page, the target area including a video interface and a page interactive element.

The determining unit 703 is configured to: determine a display area on a display screen for the target area, and obtain a scrolling value of at least one of the to-be-displayed page and the page window based on the display area.

The moving unit 704 is configured to move the at least one of the to-be-displayed page and the page window based on the scrolling value, to display the target area in the display area on the display screen.

The filling unit 705 is configured to fill an area on the display screen other than the display area with preset display information, to hide content in the area other than the display area on the display screen.

In some instances, if the target area fails to be located in the display area through movement of the to-be-displayed page, the determining unit 703 further determines, based on a current first scrolling value of the to-be-displayed page, a second scrolling value by which the page window is to be moved, to allow the target area to be located in the display area. The moving unit 704 further moves the page window based on the second scrolling value, so that the target area is located in the display area.

In some instances, the determining unit 703 may further determine, based on attribute information of the target area, the first scrolling value by which the to-be-displayed page is to be moved, to allow the target area to be located in the display area on the display screen. The first scrolling value may be expressed as follows:

newScrollyY=videoY−(webviewHeight−videoHeight)/2,

where newScrollyY represents the determined first scrolling value by which the to-be-displayed page is to be moved, videoY represents a vertical coordinate of an upper left vertex of the target area, webviewHeight represents a height of the display screen, and videoHeight represents a height of the target area.

In some instances, because the determined first scrolling value newScrollyY may be a negative value, the determining unit 703 further determines the first scrolling value by which the to-be-displayed page is to be moved. The first scrolling value may be expressed as follows:

newScrollyY=min(max(0,video−(webviewHeight−videoHeight)/2),webHeight),

where newScrollyY represents the first scrolling value by which the to-be-displayed page is to be moved, webHeight represents a height of the to-be-displayed page, webviewHeight represents a height of the display screen, and videoHeight represents a height of the target area.

In some instances, if the target area fails to be located in the display area through movement of the to-be-displayed page, the determining unit 703 further determines the second scrolling value by which the page window is to be moved. The second scrolling value may be expressed as follows:

int offsetY=(webviewHeight−videoHeight)/2−videoY+ScrollY,

where int offsetY represents the second scrolling value of the page window, webviewHeight represents a height of the display screen, videoHeight represents a height of the target area, videoY represents a vertical coordinate in position information of the target area, and ScrollY represents the first scrolling value of the to-be-displayed page.

In this embodiment of this application, the target area is displayed in a preset display area, where the target area includes the video interface and the interactive page element, and the area on the display screen other than the target area is filled with the preset display information. By this method, on one hand, a unified video playback interface can be provided to a user, thereby improving user experience; on the other hand, page interaction can be supported, thereby avoiding low efficiency caused by incapability of page interaction, and reducing processing pressure.

FIG. 8 is a schematic structural diagram of a terminal according to an embodiment of this application. The terminal provided in this embodiment of this application may be configured to perform the method in the embodiments of this application. For ease of description, a part related to this embodiment of this application is provided. For undisclosed technical details, refer to the embodiments of this application shown in FIG. 1b and FIG. 5.

As shown in FIG. 8, the terminal includes: at least one processor 801, for example, a CPU; at least one input apparatus 803, at least one output apparatus 804, a memory 805, and at least one communications bus 802. The communications bus 802 is configured to implement connection and communication between the components. The input apparatus 803 may be a network interface and the like, and is configured to obtain a to-be-displayed page. The output apparatus 804 may be a display screen and the like, and is configured to display a video interface and an interactive page element. The memory 805 may include a high-speed RAM memory, or may include a non-volatile memory such as at least one disk memory, and is configured to store the to-be-displayed page and the like. In some instances, the memory 805 may include at least one storage apparatus that is located far away from the processor 801. For the processor 801, refer to the video interface display apparatus shown in FIG. 6 and FIG. 7. The memory 805 stores a group of program code, and the processor 801, the input apparatus 803 and the output apparatus 804 invoke the program code stored in memory 805 to perform operations in the foregoing method embodiments.

The terminal described in this embodiment of this application may be configured to perform some or all of the procedures of the method embodiments in this application described with reference to FIG. 1b and FIG. 5.

A person of ordinary skill in the art may understand that all or some of the processes of the methods in the embodiments may be implemented by a computer program instructing relevant hardware. The program may be stored in a computer readable storage medium. When the program is executed, the procedures of the methods in the embodiments are performed. The foregoing storage medium may include a magnetic disc, an optical disc, a read-only memory (ROM), a random access memory (RAM), or the like.

Therefore, an embodiment of this application further provides a storage medium, which stores a data processing program. The data processing program is used for executing a foregoing method in the disclosure.

The foregoing disclosure is exemplary embodiments of this application, and certainly is not intended to limit the protection scope of this application. Therefore, equivalent variations made in accordance with the claims of this application shall fall within the scope of this application.

What is claimed is:

1. A method for video display in a terminal device, comprising:
receiving, by interface circuitry of the terminal device, web page data of a page for displaying on a display screen of the terminal device;
determining, by processing circuitry of the terminal device and from the web page data, a video playback portion of the page that includes a video interface for displaying a video and at least one interactive page element associated with the video interface;
determining, by the processing circuitry of the terminal device, a scrolling value of the page based on which the page is scrolled with regard to the display screen of the terminal device to display the video playback portion in a specific area of the display screen; and
filling, by the processing circuitry, preset display content in an area other than the specific area on the display screen such that the preset display content is displayed in the area other than the specific area and the video playback portion is displayed in the specific area on the display screen.

2. The method of claim 1, further comprising:
determining, by the processing circuitry and from the web page data, position information and size information of the video playback portion of the page, the position information including a vertex of the video playback portion in a coordinate system, and the size information of the video playback portion including a height of the video playback portion.

3. The method of claim 2, further comprising:
determining, by the processing circuitry, a first scrolling value for the page based on the position information of the video playback portion, the first scrolling value being used for the page to be scrolled such that the video playback portion is displayed in the specific area.

4. The method of claim 3, further comprising:
determining, by the processing circuitry, a second scrolling value for a page window of the terminal device based on the first scrolling value, the page window being used for displaying the page, and the second scrolling value being used for the page window to be scrolled such that the video playback portion is displayed in the specific area.

5. The method of claim 3, wherein the first scrolling value for the page is expressed as follows:
newScrollyY=videoY−(webviewHeight−videoHeight)/2,
newScrollyY representing the first scrolling value for the page, videoY representing a vertical coordinate of the vertex of the video playback portion, webviewHeight representing a height of the display screen of the terminal device, and videoHeight representing the height of the video playback portion.

6. The method of claim 3, wherein the first scrolling value for the page is expressed as follows:
newScrollyY=min(max(0,videoY−(webviewHeight−videoHeight)/2),webHeight),
newScrollyY representing the first scrolling value for the page, videoY representing the vertical coordinate of the vertex of the video playback portion, webviewHeight representing the height of the display screen, videoHeight representing the height of the video playback portion, webHeight representing a height of the page, min( ) representing a minimum value being output in response to inputs between a paired parentheses, and max( ) representing a maximum value being output in response to inputs between a paired parentheses.

7. The method of claim 4, wherein the second scrolling value for the page window is expressed as follows:
int offsetY=(webviewHeight−videoHeight)/2−videoY+ScrollY,
int offsetY representing the second scrolling value for the page window, webviewHeight representing the height of the display screen, videoHeight representing the height of the video playback portion, videoY representing the vertical coordinate of the vertex of the video playback portion, and ScrollY representing first scrolling value for the page.

8. A terminal device for video display, comprising:
processing circuitry configured to:
receive web page data of a page for displaying on a display screen of the terminal device;
determine, from the web page data, a video playback portion of the page that includes a video interface for displaying a video and at least one interactive page element associated with the video interface;
determine a scrolling value of the page based on which the page is scrolled with regard to the display screen of the terminal device to display the video playback portion in a specific area of the display screen; and
fill preset display content in an area other than the specific area on the display screen such that the preset display content is displayed in the area other than the specific area and the video playback portion is displayed in the specific area on the display screen.

9. The terminal device of claim 8, wherein the processing circuitry is further configured to:
determine, from the web page data, position information and size information of the video playback portion of the page, the position information including a vertex of the video playback portion in a coordinate system, and the size information of the video playback portion including a height of the video playback portion.

10. The terminal device of claim 9, wherein the processing circuitry is further configured to:
determine a first scrolling value for the page based on the position information of the video playback portion, the first scrolling value being used for the page to be scrolled such that the video playback portion is displayed in the specific area.

11. The terminal device of claim 10, wherein the processing circuitry is further configured to:
determine a second scrolling value for a page window of the terminal device based on the first scrolling value, the page window being used for displaying the page, and the second scrolling value being used for the page window to be scrolled such that the video playback portion is displayed in the specific area.

12. The terminal device of claim 10, wherein the first scrolling value for the page is expressed as follows:
newScrollyY=videoY−(webviewHeight−videoHeight)/2,
newScrollyY representing the first scrolling value for the page, videoY representing a vertical coordinate of the vertex of the video playback portion, webviewHeight representing a height of the display screen of the terminal device, and videoHeight representing the height of the video playback portion.

13. The terminal device of claim 10, wherein the first scrolling value for the page is expressed as follows:
newScrollyY=min(max(0,videoY−(webviewHeight−videoHeight)/2),webHeight),
newScrollyY representing the first scrolling value for the page, videoY representing the vertical coordinate of the vertex of the video playback portion, webviewHeight representing the height of the display screen, videoHeight representing the height of the video playback portion, webHeight representing a height of the page, min( ) representing a minimum value being output in response to inputs between a paired parentheses, and max( ) representing a maximum value being output in response to inputs between a paired parentheses.

14. The terminal device of claim 11, wherein the second scrolling value for the page window is expressed as follows:
int offsetY=(webviewHeight−videoHeight)/2−videoY+ScrollY,
int offsetY representing the second scrolling value for the page window, webviewHeight representing the height of the display screen, videoHeight representing the height of the video playback portion, videoY representing the vertical coordinate of the vertex of the video playback portion, and ScrollY representing first scrolling value for the page.

15. A non-transitory computer-readable medium storing computer-readable instructions therein which when executed by a computer cause the computer to perform:
receiving web page data of a page for displaying on a display screen of the terminal device;
determining, from the web page data, a video playback portion of the page that includes a video interface for displaying a video and at least one interactive page element associated with the video interface;
determining a scrolling value of the page based on which the page is scrolled with regard to the display screen of the terminal device to display the video playback portion in a specific area of the display screen; and
filling preset display content in an area other than the specific area on the display screen such that the preset display content is displayed in the area other than the specific area and the video playback portion is displayed in the specific area on the display screen.

16. The non-transitory computer-readable medium of claim 15, wherein the storing computer-readable instructions which when executed by the computer cause the computer to further perform:
determining, from the web page data, position information and size information of the video playback portion of the page, the position information including a vertex of the video playback portion in a coordinate system, and the size information of the video playback portion including a height of the video playback portion.

17. The non-transitory computer-readable medium of claim 16, wherein the storing computer-readable instructions which when executed by the computer cause the computer to further perform:
determining a first scrolling value for the page based on the position information of the video playback portion, the first scrolling value being used for the page to be scrolled such that the video playback portion is displayed in the specific area.

18. The non-transitory computer-readable medium of claim 17, wherein the storing computer-readable instructions which when executed by the computer cause the computer to further perform:
determining a second scrolling value for a page window of the terminal device based on the first scrolling value, the page window being used for displaying the page, and the second scrolling value being used for the page window to be scrolled such that the video playback portion is displayed in the specific area.

19. The non-transitory computer-readable medium of claim 17, wherein the first scrolling value for the page is expressed as follows:
newScrollyY=videoY−(webviewHeight−videoHeight)/2,
newScrollyY representing the first scrolling value for the page, videoY representing a vertical coordinate of the vertex of the video playback portion, webviewHeight representing a height of the display screen of the terminal device, and videoHeight representing the height of the video playback portion.

20. The non-transitory computer-readable medium of claim 17, wherein the first scrolling value for the page is expressed as follows:
newScrollyY=min(max(0,videoY−(webviewHeight−videoHeight)/2),webHeight),
newScrollyY representing the first scrolling value for the page, videoY representing the vertical coordinate of the vertex of the video playback portion, webviewHeight representing the height of the display screen, videoHeight representing the height of the video playback portion, webHeight representing a height of the page, min( ) representing a minimum value being output in response to inputs between a paired parentheses, and max( ) representing a maximum value being output in response to inputs between a paired parentheses.
